(19) United States
(12) Patent Application Publication
(10) Pub. No.: US 2016/0057350 A1
(43) Pub. Date: Feb. 25, 2016

(54) IMAGING APPARATUS, IMAGE PROCESSING METHOD, AND NON-TRANSITORY COMPUTER-READABLE MEDIUM

(71) Applicant: Shinobu UEZONO, Kanagawa (JP)

(72) Inventor: Shinobu UEZONO, Kanagawa (JP)

(73) Assignee: RICOH COMPANY, LIMITED, Tokyo (JP)

(21) Appl. No.: 14/824,639

(22) Filed: Aug. 12, 2015

(30) Foreign Application Priority Data
Aug. 20, 2014 (JP) 2014-167158

(51) Int. Cl. H04N 5/232; H04N 5/272; H04N 5/14

(52) U.S. Cl. CPC H04N 5/23261; H04N 5/23293; H04N 5/23238; H04N 5/144; H04N 5/272; H04N 5/23229

(57) ABSTRACT

An imaging apparatus includes: an image-acquiring unit that acquires an image of an object of photography through a lens; an image display unit that displays the image acquired by the image-acquiring unit to an operator; an angular movement amount detecting unit that detects an angular movement amount of the imaging apparatus; an image movement amount calculation unit that calculates an image movement amount based on the angular movement amount detected by the angular movement amount detecting unit; and an object-position display unit that displays a current position of the object of photography superimposed onto the image displayed by the image display unit based on the image movement amount calculated by the image movement amount calculation unit.

### CROSS-REFERENCE TO RELATED APPLICATIONS

The present application claims priority to and incorporates by reference the entire contents of Japanese Patent Application No. 2014-167158 filed in Japan on Aug. 20, 2014.

### BACKGROUND OF THE INVENTION

1. Field of the Invention

The present invention relates to an imaging apparatus, an image processing method, and a non-transitory computer-readable medium.

2. Description of the Related Art

The method of superimposing a plurality of images with each other has been known as a technique to photograph an object of photography that an operator can hardly see in a dark scene at night, for example. With this method, an image virtually exposed for a long time can be generated. If the method is applied to a handy camera, a conventional technology to integrate images after alignment and/or transformation of images is used.

For example, a conventional technology in Japanese Patent Application Laid-open No. 2000-224460 has been developed that can acquire high-resolution images even if an object of photography is photographed with a handy camera in a dark scene. In the picture signal processor disclosed in Japanese Patent Application Laid-open No. 2000-224460, a plurality of images are captured with shorter exposure time, the positional displacement of the captured images are corrected in a range of equal to or smaller than one pixel. The corrected images are then integrated and averaged to generate a high-quality image.

In the method disclosed in Japanese Patent Application Laid-open No. 60-143330, swinging of a camera apparatus is detected and images captured by the camera apparatus are corrected to acquire a stable image by using an optical axis correcting unit such as a mirror.

These conventional technologies can generate images used for recognizing an object of photography by integrating a plurality of captured images even if an operator cannot visually recognize the object of photography through a viewfinder of the camera apparatus in a dark scene. In this case, it is preferable that a larger number of images be captured for the image integration.

An image of the object of photography needs to be positioned within a captured image. In a particularly dark scene, however, capturing an image of the object of photography with accuracy is difficult because of camera-shaking. Severe camera-shaking may shift the image of the object of photography out of the photographing range of the camera apparatus.

In the picture signal processor disclosed in Japanese Patent Application Laid-open No. 2000-224460, even if captured images of an object of photography are displaced to some extent due to the camera-shaking, a high-resolution image can be generated by correcting the displacement and integrating many thus corrected images with each other.

However, an image of the object of photography that is completely out of the photographing range cannot be used for image integration. In addition, a part of an image of the object of photography being out of the photographing range may reduce the efficiency of the image integration. Such issues have not been considered for the picture signal processor disclosed in Japanese Patent Application Laid-open No. 2000-224460.

In the camera apparatus disclosed in Japanese Patent Application Laid-open No. 60-143330, the displacement of captured images caused by the camera-shaking can be corrected. However, if the whole or a part of an image of the object of photography is out of the photographing range, the image correction alone cannot generate a high-quality image.

That is, the conventional technologies simply reduce the effects of the camera-shaking on image quality. To completely solve the issues, preventing an operator from causing the camera-shaking, or reducing the degree of the camera-shaking is required. However, the issues have not been considered in the conventional technologies.

Therefore, it is desirable to provide an imaging apparatus, an image processing method, and a non-transitory computer-readable medium capable of imaging an object of photography with high quality in a dark scene.

### SUMMARY OF THE INVENTION

It is an object of the present invention to at least partially solve the problems in the conventional technology.

According to an aspect of the present invention, there is provided an imaging apparatus including: an image-acquiring unit that acquires an image of an object of photography through a lens; an image display unit that displays the image acquired by the image-acquiring unit to an operator; an angular movement amount detecting unit that detects an angular movement amount of the imaging apparatus; an image movement amount calculation unit that calculates an image movement amount based on the angular movement amount detected by the angular movement amount detecting unit; and an object-position display unit that displays a current position of the object of photography superimposed onto the image displayed by the image display unit based on the image movement amount calculated by the image movement amount calculation unit.

According to another aspect of the present invention, there is provided an image processing method including: acquiring an image of an object of photography through a lens of an imaging apparatus; displaying the image acquired at the acquiring to an operator; detecting an angular movement amount of the imaging apparatus; calculating an image movement amount based on the angular movement amount detected at the detecting of the angular movement amount; and displaying a current position of the object of photography superimposed onto the image displayed at the displaying the image acquired based on the image movement amount calculated at the calculating.

According to still another aspect of the present invention, there is provided a non-transitory computer-readable medium including computer readable program codes, performed by a processor, the program codes when executed causing the processor to execute: acquiring an image of an object of photography through a lens of an imaging apparatus; displaying the image acquired at the acquiring to an operator; detecting an angular movement amount of the imaging apparatus; calculating an image movement amount based on the angular movement amount detected at the detecting of the angular movement amount; and displaying a current position of the object of photography superimposed onto the image displayed at the displaying the image acquired based on the image movement amount calculated at the calculating.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a flowchart illustrating operations of an imaging apparatus according to a first embodiment of the present invention;

FIG. 2 is a block diagram illustrating the configuration of the imaging apparatus according to the first embodiment;

FIG. 3 is a diagram illustrating operations of the imaging apparatus according to the first embodiment and operations of a conventional imaging apparatus;

FIG. 4 is diagrams illustrating operations of the imaging apparatus according to the first embodiment and operations of a conventional imaging apparatus;

FIG. 5 is a front view illustrating the imaging apparatus according to the first embodiment;

FIG. 6 is a rear view illustrating the imaging apparatus according to the first embodiment;

FIG. 7 is a plan view illustrating the imaging apparatus according to the first embodiment;

FIG. 8 is a block diagram illustrating the configuration of the imaging apparatus according to the first embodiment;

FIG. 9 is a flowchart illustrating operations of the imaging apparatus according to the first embodiment;

FIG. 10 is a diagram illustrating operations of an imaging apparatus according to a second embodiment; and

FIG. 11 is a diagram illustrating operations of an imaging apparatus according to a third embodiment.

### DETAILED DESCRIPTION OF THE PREFERRED EMBODIMENTS

The typical configuration and operations of a digital camera

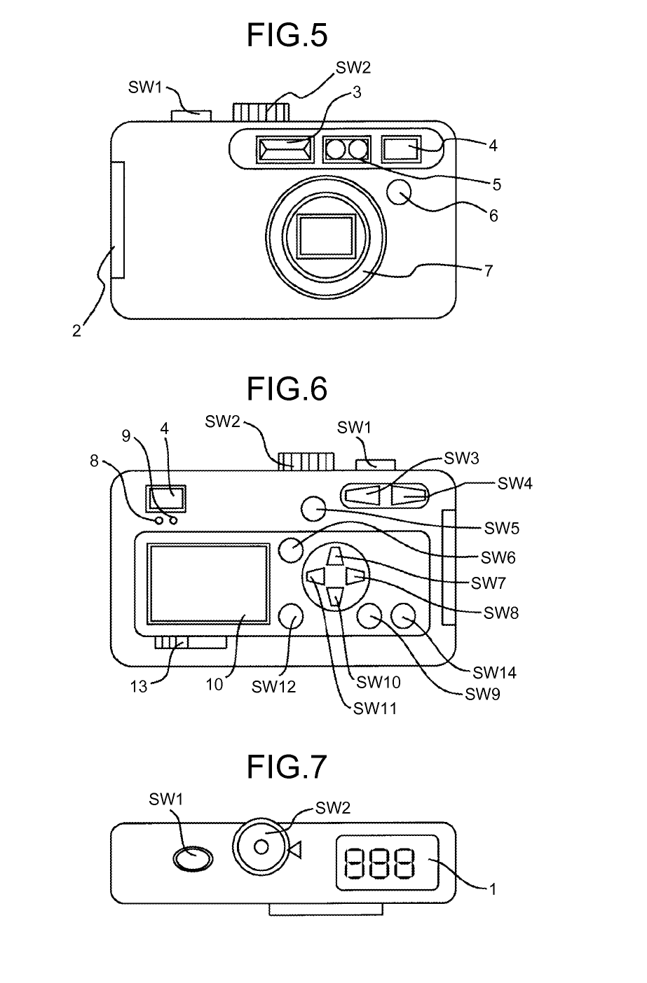

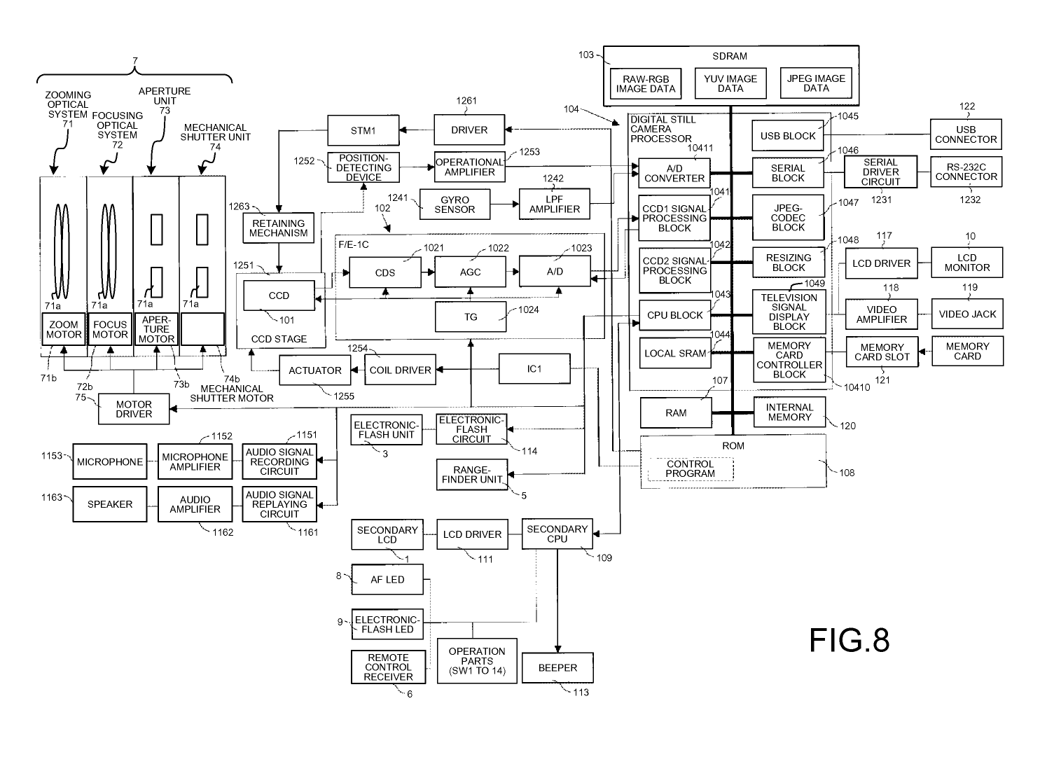

FIGS. 5 to 8 illustrate the configuration of a digital camera serving as an imaging apparatus according to an embodiment of the present invention. FIG. 5 is a front view illustrating a digital camera, FIG. 6 is a rear view of the digital camera illustrated in FIG. 5, FIG. 7 is a plan view of the digital camera illustrated in FIG. 5, and FIG. 8 is a block diagram schematically illustrating the outline of the system configuration of the digital camera illustrated in FIG. 5.

As illustrated in FIGS. 5 to 7, a release button SW1 serving as a shutter button, a mode dial SW2, and a secondary LCD 1 serving as a liquid crystal display are disposed on the upper surface portion of the camera body.

As illustrated in FIG. 5, an electronic-flash unit 3, a range-finder unit 5, and a remote control receiver 6 are disposed on the front portion of the camera body. An optical viewfinder 4 has its objective side provided on the front portion of the camera body, and a lens barrel unit 7 also has its objective side provided on the front portion of the camera body. The lens barrel unit 7 includes a taking lens.

As illustrated in FIG. 6, a power switch SW13, an LCD monitor 10, an AF-LED 8, an electronic-flash LED 9, a wide-angle zoom switch SW3, and a telephoto zoom switch SW4 are disposed on the rear portion of the camera body. A self-timer switch SW5, a menu switch SW6, an up/electronic-flash switch SW7, a right switch SW8, and a display switch SW9 are also disposed thereon.

In addition, a down/macro switch SW10, a left/picture review switch SW11, an enter switch SW12, and a camera-shake correction switch SW14 are disposed thereon. The optical viewfinder 4 has its principal part housed in the camera body and its ocular side disposed on the rear portion. On the side portion of the camera body, a memory card/battery-compartment cover 2 is provided.

Next, the following describes the system configuration of a processing circuit housed in the camera body of the digital camera with reference to FIG. 8. As illustrated in FIG. 8, a processor 104 serving as a processing unit of the processing circuit executes various types of processing in a digital camera.

The processor 104 includes an A/D converter 10411, a first CCD signal processing block 1041, a second CCD signal processing block 1042, and a CPU block 1043. The processor 104 also includes a local SRAM 1044, a USB block 1045, a serial block 1046, and a JPEG-CODEC block 1047.

In addition, the processor 104 includes a resizing block 1048, a television signal display block 1049, and a memory card controller block 10410, which are coupled to each other through a bus line.

To the processor 104, a synchronous dynamic random access memory (SDRAM) 103 is coupled through a bus line. The SDRAM 103 stores therein RAW-RGB image data that is RGB raw data in which a piece of image data has been simply subjected to white balance or gamma processing. The SDRAM 103 also stores therein a piece of image data such as YUV image data in which image data has been converted into luminance and color difference data in YUV or JPEG image data in which image data has been compressed in the JPEG format.

To the processor 104, a random access memory (RAM) 107, an internal memory 120, and a read only memory (ROM) 108 are coupled through a bus line. The internal memory 120 stores therein photographed image data if no memory card MC is inserted in a memory card slot 121. The ROM 108 records therein a control program and parameters, for example.

If the power switch SW13 is turned on, the control program is loaded on a main memory of the processor 104 that in turn controls operations of the components and units according to the control program. The main memory may be the RAM 107, the local SRAM 1044, or a memory embedded in the CPU block 1043. In association with this control, the control data and the parameters are temporarily stored in the RAM 107, for example.

The lens barrel unit 7 includes a zooming optical system 71 with a zoom lens 71a, and a focusing optical system 72 with a focus lens 72a. The lens barrel unit 7 also includes a lens barrel housing an aperture unit 73 with an aperture 73a and a mechanical shutter unit 74 with a mechanical shutter 74a.

The zooming optical system 71, the focusing optical system 72, the aperture unit 73, and the mechanical shutter unit 74 are driven by a zoom motor 71b, a focus motor 72b, an aperture motor 73b, and a mechanical shutter motor 74b, respectively. These motors are driven by a motor driver 75 that is controlled by the CPU block 1043 of the processor 104.

An image of the object of photography is formed in a CCD solid-state imaging device 101 through the lenses of the lens barrel unit 7. The CCD solid-state imaging device 101 converts the image of the object of photography into image signals and outputs the image signals to a front-end integrated circuit (F/E-IC) 102.

The F/E-IC 102 includes a correlated double sampling (CDS) 1021, an automatic gain control (AGC) 1022, and an analog-digital (A/D) converter unit 1023. The CDS 1021 is used for executing correlated double sampling to remove image noises, the AGC 1022 is used for executing automatic gain control, and the A/D converter unit 1023 is used for executing analog-digital conversion.

That is, the F/E-IC 102 executes certain processing on the image signals and converts the analog image signals into digital image data. The F/E-IC 102 then supplies the digital image data to the first CCD signal processing block 1041 of the processor 104.

The signal control processing is executed using a vertical synchronizing signal VD and a horizontal synchronizing signal HD output by the first CCD signal processing block 1041 of the processor 104 through a timing generator (TG) 1024. The TG 1024 generates a drive timing signal based on the vertical synchronizing signal VD and the horizontal synchronizing signal HD.

The first CCD signal processing block 1041 performs white balance adjustment setting or gamma adjustment setting on the digital image data input from the CCD solid-state imaging device 101 through the F/E-IC 102. The first CCD signal processing block 1041 also outputs the VD signal and the HD signal. The second CCD signal processing block 1042 converts the signals into luminance and color difference data through filtering.

The CPU block 1043 controls operations of the components and units such as the motor driver 75 and the CCD solid-state imaging device 101 of the digital camera according to the control program stored in the ROM 108 based on the signals input through the remote control receiver 6 or the operation parts SW1 to SW14.

The local SRAM 1044 temporarily stores therein the data required for controlling the CPU block 1043. The USB block 1045 executes processing for communication with an external device such as a PC using a USB interface. The serial block 1046 executes processing for serial communication with an external device such as a PC.

The JPEG-CODEC block 1047 compresses and decompresses image data in the JPEG format. The resizing block 1048 executes processing of enlarging and reducing the size of the image data through interpolating, for example. The television signal display block 1049 executes processing of converting the image data into video signals for display on an external device such as the LCD monitor 10 or a television.

The memory card controller block 10410 controls the memory card MC that records thereon the photographed image data. The CPU block 1043 of the processor 104 controls an audio signal recording circuit 1151 to record audio. The audio signal recording circuit 1151 operates in response to a command. The audio signal recording circuit 1151 records an audio signal detected by a microphone 1153, converted into an electric signal, and amplified by a microphone amplifier 1152.

The CPU block 1043 also controls operations of an audio signal replaying circuit 1161. The audio signal replaying circuit 1161 operates in response to a command. The audio signal replaying circuit 1161 controls an audio amplifier 1162 to amplify the audio signal recorded in various types of memory and controls the speaker 1163 to reproduce the audio signal. The CPU block 1043 also controls an electronic-flash circuit 114 to emit illumination light from the electronic-flash unit 3. The CPU block 1043 also controls the range-finder unit 5 to measure the distance to the object of photography.

The CPU block 1043 is also couples to a secondary CPU 109 that controls the secondary LCD 1 through a secondary LCD driver 111 to display an image. In addition, the secondary CPU 109 is coupled to the AF-LED 8, the electronic-flash LED 9, the remote control receiver 6, the operation parts including the operation switches SW1 to SW14, and a beeper 113.

The USB block 1045 is coupled to a USB connector 122 and the serial block 1046 is coupled to an RS-232C connector 1232 through a serial driver 1231.

The television signal display block 1049 is coupled to the LCD monitor 10 through an LCD driver 117. The television signal display block 1049 is also coupled to a video jack 119 through a video amplifier 118 that converts the video signal into a video output with an impedance of 75Ω, for example.

The memory card controller block 10410 is coupled to a memory card slot 121 and controls the read and write from and to the memory card MC inserted into the memory card slot 121.

The LCD driver 117 converts the video signal output from the television signal display block 1049 into a signal for display on the LCD monitor 10. The LCD driver 117 then drives the LCD monitor 10 to display an image. The LCD monitor 10 is used for monitoring the state of the object of photography before being photographed and reviewing the photograph image. The LCD monitor 10 is also used for displaying the image data recorded on the memory card or the internal memory 120.

In the digital camera, the lens barrel unit 7 includes a fixation barrel. In the fixation barrel, a CCD stage 1251 is movably provided in the X-Y direction. The CCD solid-state imaging device 101 is mounted on the CCD stage 1251 included in a camera-shake correction mechanism.

The CCD stage 1251 is driven by an actuator 1255 that is controlled and driven by a coil driver 1254. The coil driver 1254 includes a coil drive MD1 and a coil drive MD2.

The coil driver 1254 is coupled to an A/D converter IC1 coupled to the ROM 108 that supplies the A/D converter IC1 with the control data.

In the fixation barrel, an original-position forced-retaining mechanism 1263 is provided for retaining the CCD stage 1251 in the central position if the camera-shake correction switch SW14 is off and the power switch SW13 is off. The original-position forced-retaining mechanism 1263 is controlled by a stepping motor STM1 serving as an actuator that is driven by a driver 1261. To the driver 1261, the control data is also input from the ROM 108.

On the CCD stage 1251, a position-detecting device 1252 is mounted. The detection output by the position-detecting device 1252 is input to an operational amplifier 1253, amplified, and input to the A/D converter 10411.

On the camera body, a gyro sensor 1241 is provided that can detect rotation in the X and Y directions. The detection output of the gyro sensor 1241 is input to the A/D converter 10411 through an LPF amplifier 1242 including the function of low-pass filter.

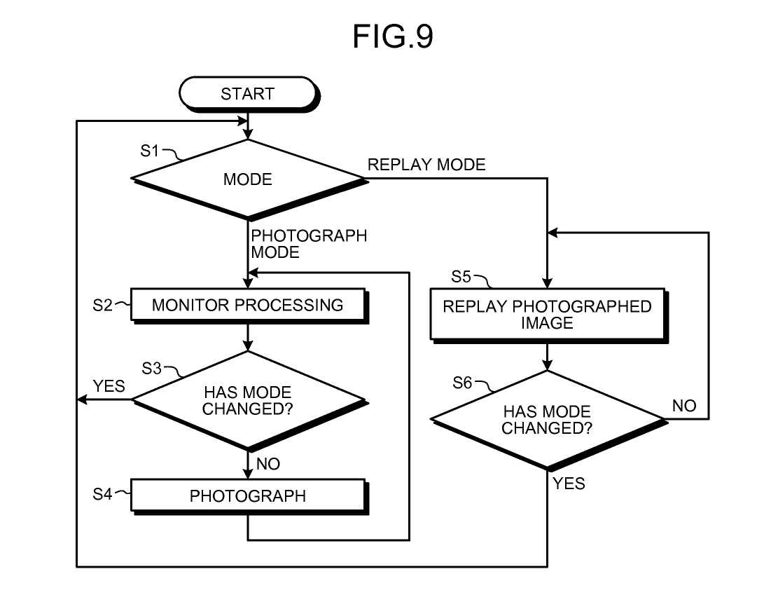

The following describes typical operations of a digital camera according to the embodiment with reference to FIG. 9. If the mode dial SW2 is set to a shooting mode, the camera is started in the shooting mode. If the mode dial SW2 is set to a playback mode, the camera is started in the playback mode. The processor 104 determines whether the mode dial SW2 is set to the shooting mode or the playback mode (Step S1).

The processor 104 controls the motor driver 75 to move the lens barrel of the lens barrel unit 7 to a position where photography can be performed. In addition, the processor 104 supplies power to the respective circuits of the CCD solid-state imaging device 101, the F/E-IC 102, and the LCD monitor 10, for example, to start their operations. Supplying power to the circuits starts operations in the shooting mode.

In the shooting mode, the light that has entered the CCD solid-state imaging device 101 serving as an imaging device through the lens systems is subjected to photoelectric conversion to be converted into analog signals of red (R), green (G), and blue (B). The converted analog signals are then transmitted to the CDS 1021 and the A/D converter unit 1023.

The A/D converter unit 1023 converts the input analog signals into digital signals. The converted digital signals are then converted into YUV data through a YUV (luminance and color difference signals) conversion function of the second CCD signal processing block 1042 in the processor 104. The converted YUV data is then written in the SDRAM 103 serving as a frame memory.

The YUV signals are read by the CPU block 1043 of the processor 104 and transmitted to an external device such as a television or the LCD monitor 10 through the television signal display block 1049 for display of the photograph image. The processing is executed in a cycle of 1/30 second to perform display on an electronic view finder in the shooting mode that is updated in a cycle of 1/30 second.

That is, monitor processing is executed (Step S2). Subsequently, the processor 104 determines whether the setting of the mode dial SW2 has changed (Step S3). If the setting of the mode dial SW2 has not changed, photographing processing is executed based on an operation of the release button SW1 (Step S4).

In the playback mode, the processor 104 controls the LCD monitor 10 to display a photographed image (Step S5). The processor 104 determines whether the setting of the mode dial SW2 has changed (Step S6). If the setting of the mode dial SW2 has changed, the process sequence proceeds to Step S1. If setting of the mode dial SW2 has not changed, the process sequence repeats Step S5.

The fundamental configuration and operations of imaging apparatuses according to the embodiments described later may be the same as those of the above-described typical digital camera.

The configuration and operations of an imaging apparatus according to a first embodiment

The following describes the configuration and operations of an imaging apparatus according to a first embodiment. FIG. 3 illustrates an example of the temporal transition of the center sight-line position from a camera according to the first embodiment of the present invention and a camera according to a conventional related art.

The trajectory T1 in FIG. 3 illustrates the temporal transition of a point corresponding to the center sight-line position from a camera according to a conventional art. The trajectory T2 in FIG. 3 illustrates the temporal transition of a point corresponding to the center sight-line position from a camera according to the first embodiment of the present invention. As illustrated in FIG. 3, if the object of photography cannot be visually recognized at all, the sight-line position gradually deviates from the original position when using a conventional handy camera. This event is more remarkable with smaller angle of view.

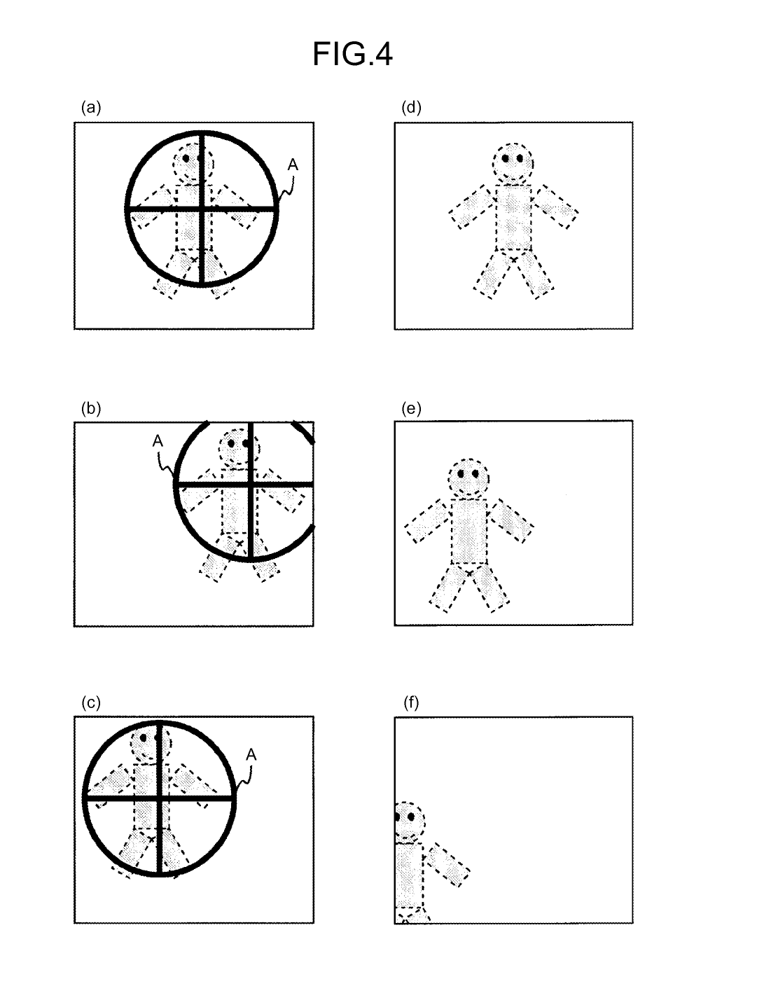

FIGS. 4(a) to 4(f) illustrate examples of display on a finder according to the first embodiment of the present invention and according to a conventional related art. The dotted lines in FIGS. 4(a) to 4(f) represent that an operator cannot actually view the object of photography in a dark scene. FIGS. 4(a) to 4(c) illustrate the display according to the first embodiment of the present invention and FIGS. 4(d) to 4(f) illustrate the display according to a conventional related art.

As illustrated in FIGS. 4(a) to 4(c), a navigation A is displayed on an electronic view finder 55 for an operator to keep watching an identical point of the object of photography in the finder according to the first embodiment of the present invention, and the operator tries to move the camera so as to position the navigation A in the center of the electronic view finder 55. By contrast, according to the conventional related art, completely dark display makes it difficult for the operator to keep positioning the object of photography within the frame. As a result, the sight-line position gradually deviates from the original position as represented with the trajectory T1 in FIG. 3. This event is more remarkable with larger focal length.

For example, when the state illustrated in FIG. 4(a) is changed to that in FIG. 4(b), the navigation A indicates that the position of the object of photography has deviated from the initial position toward the upper right in the frame. The operator can move the camera toward the upper right so as to position the navigation A in the center of the frame. In the same manner, in FIG. 4(c), the navigation A indicates that the position of the object of photography has deviated from the initial position toward the left in the frame. In this example, the operator can move the camera to the left side, thereby positioning the object of photography in the center of the frame.

By contrast, as illustrated in FIGS. 4(d), 4(e), and 4(f), which all illustrate photographing using the conventional camera, no indication is provided for informing the operator of deviation of the object of photography from the center, and the operator cannot correct the deviation.

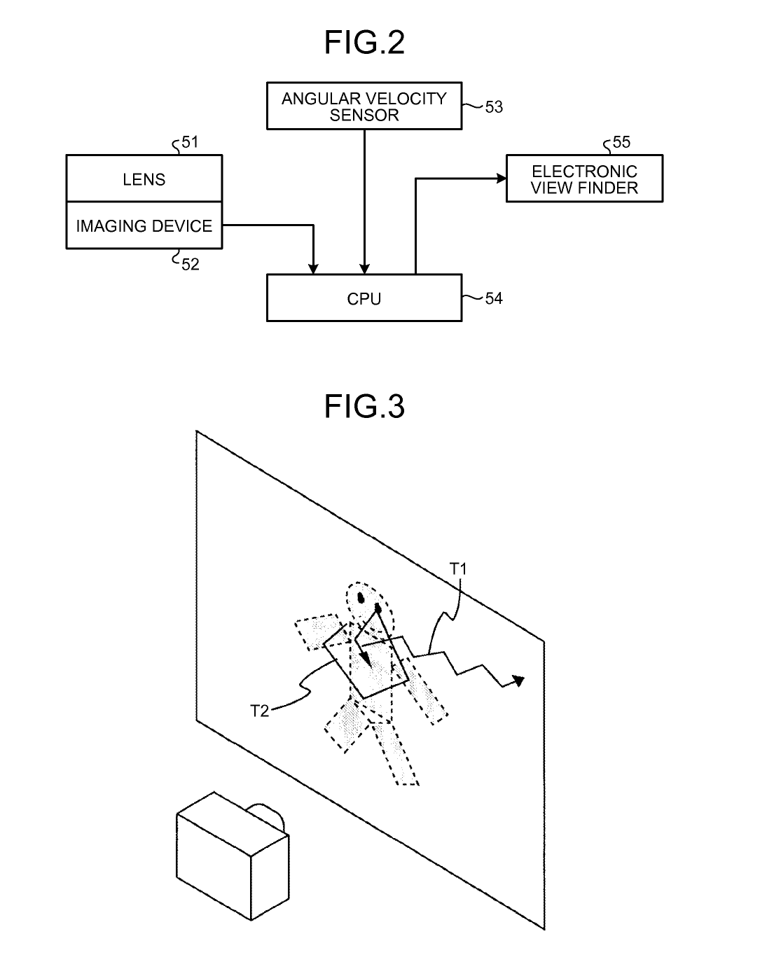

FIG. 2 is a block diagram simply illustrating extracted unique portions in the first embodiment of the present invention. The image acquired on the lens 51 is transmitted to the CPU 54 through the imaging device 52 serving as an image-acquiring unit. On this occasion, an angular velocity sensor 53 serving as an angular movement amount detecting unit acquires the movement of the imaging apparatus itself as an angle. The CPU 54 converts the angular movement amount into an image movement amount and superimposes it onto the image of the object of photography, thereby displaying the navigation A on the electronic view finder 55.

The CPU 54 calculates in advance the conversion amount used for converting the angular movement amount into the image movement amount obtained based on the focal length and the pitch of the imaging device. In this case, the CPU 54 functions as an image movement amount calculation unit and the navigation A functions as an object-position display unit.

Specifically, the lens systems in the lens barrel unit 7 and the CCD solid-state imaging device 101 illustrated in FIG. 8 function as the lens 51 and the imaging device 52 illustrated in FIG. 2, respectively. The angular velocity sensor 53 illustrated in FIG. 2 is the gyro sensor 1241 illustrated in FIG. 8.

The CPU block 1043 illustrated in FIG. 8 functions as the CPU 54 illustrated in FIG. 2. The image of the object of photography and the navigation A may be displayed on the LCD monitor 10 rather than the electronic view finder 55.

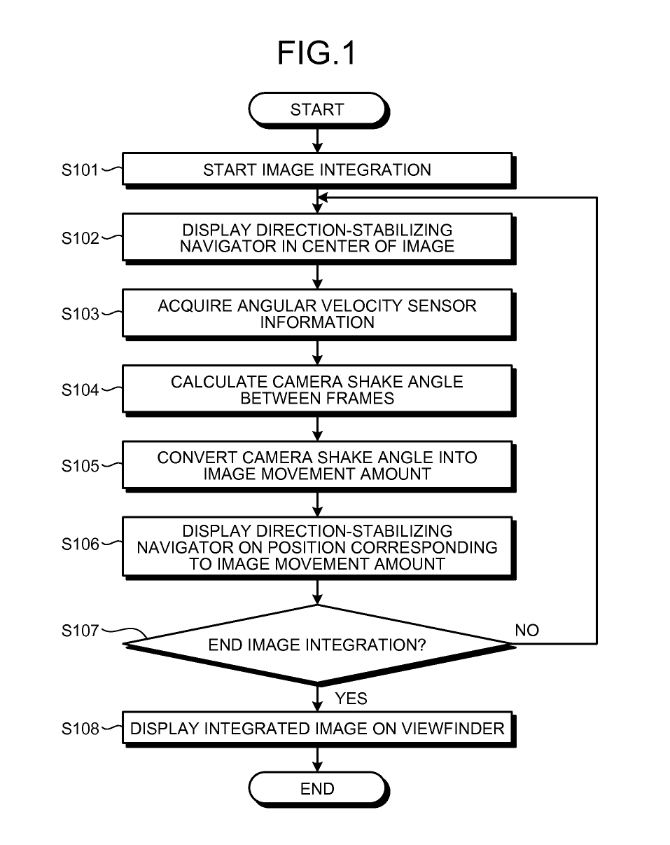

FIG. 1 is a flow of the process executed by the CPU 54 illustrated in FIG. 2. If an instruction by the operator, for example, starts image integration (Step S101), the CPU displays a direction-stabilizing navigator, that is, the navigation A illustrated in FIGS. 4(a) to 4(c) in the center of the image (Step S102).

The CPU acquires angular velocity information from the angular velocity sensor in a certain sampling pitch in real time between the frames (Step S103). The CPU integrates the pieces of the acquired information, thereby calculating the angular movement amount between the frames (Step S104). If the sampling pitch is 30 fps, for example, the time period per frame is about 33 msec.

The CPU converts the angular movement amount between the frames into the image movement amount by using the conversion amount for converting the angle into the pixel (Step S105). The CPU displays the direction-stabilizing navigator on a position corresponding to the movement amount (Step S106). The CPU continues the above-described processes until the end of image integration (No at Step S107). The image integration is ended by the CPU in response to an instruction by the operator, a certain number of images integrated, or a certain degree of brightness achieved on the image (Yes at Step S107). Subsequently, the CPU outputs the integrated image on the viewfinder (Step S108).

With the imaging apparatus according to the first embodiment of the present invention, displaying the direction-stabilizing navigator on the viewfinder enables the operator to position the image of the object of photography in the center of the viewfinder by using the direction-stabilizing navigator as a guide even if the user cannot visually recognize the object of photography at all in a dark scene.

The configuration and operations of an imaging apparatus according to a second embodiment

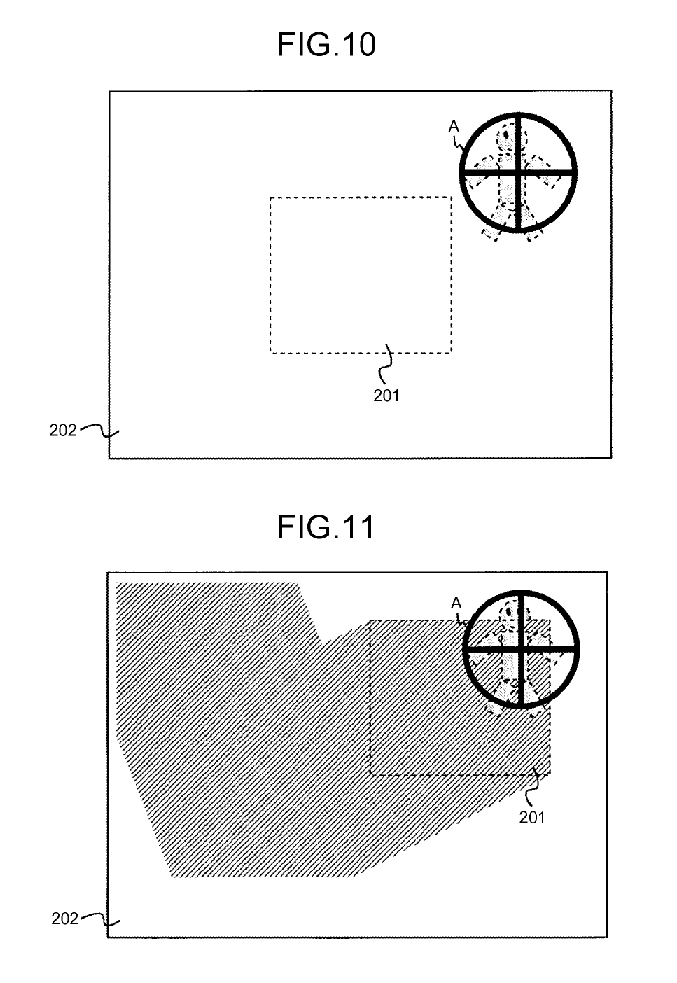

The following describes the configuration and operations of an imaging apparatus according to a second embodiment. The fundamental configuration and operations are the same as those in the first embodiment. In the first embodiment, an image of only the range to be photographed is displayed on the viewfinder. By contrast, with the imaging apparatus in the second embodiment, an image of a range wider than the range to be photographed is displayed on the viewfinder, as illustrated in FIG. 10. In FIG. 10, the range 201 represented with a dotted line is the range to be photographed and the range 202 represented with a solid line is the range displayed on a finder 205.

This configuration enables the operator to recognize where the navigation A is currently indicating even if the object of photography and the navigation A are out of the range of photographing. The viewfinder may display an image of a range relatively wider than the range of photographing. Specifically, the viewfinder may display a reduced-sized image or have a larger-sized screen.

The configuration and operations of an imaging apparatus according to a third embodiment

In an imaging apparatus in a third embodiment, an image of a range wider than the range to be photographed is displayed on the viewfinder, as illustrated in FIG. 11, in the same manner as the second embodiment. The operator can tilt the camera up and down, and toward right and left, so as to move the range 201 of photographing across the entire area of the range 202 to be displayed, and images of the entire area of the range 202 are superimposed.

As represented with hatched lines in FIG. 11, the range where the image integration has been completed is painted within the displayed range 202. This operation executes the image integration over the entire area of the range 202 to be displayed, thereby generating a wide-angle image. In this case, the range of photographing represented with the dotted line is determined based on the size of the imaging device and the focal length of the lens. The processing such as the movement of the navigation A and the image integration may be executed by the CPU 54 illustrated in FIG. 2, and in this case, the CPU 54 functions as a wide-angle image generating unit.

The computer program for executing the processing in the embodiments can be installed, for example, in the ROM 108 in the imaging apparatus illustrated in FIG. 8 as an image processing program and executed.

The computer program can be recorded on a removable recording medium transiently or persistently. Such a removable recording medium can be provided as packaged software. Examples of the removable recording medium include a magnetic disk, a semiconductor memory, and other recording media.

The computer program may be installed in a computer from the removable recording medium as described above. In addition, the computer program may be transferred from a download site to a computer through a wireless or wired network and installed therein.

The present embodiments can provide an imaging apparatus capable of imaging an object of photography with high quality in a dark scene.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An imaging apparatus comprising:
an image-acquiring unit that acquires an image of an object of photography through a lens;
an image display unit that displays the image acquired by the image-acquiring unit to an operator;
an angular movement amount detecting unit that detects an angular movement amount of the imaging apparatus;
an image movement amount calculation unit that calculates an image movement amount based on the angular movement amount detected by the angular movement amount detecting unit; and
an object-position display unit that displays a current position of the object of photography superimposed onto the image displayed by the image display unit based on the image movement amount calculated by the image movement amount calculation unit.

2. The imaging apparatus according to claim 1, wherein the image display unit displays an image of a range wider than a range of an image to be photographed.

3. The imaging apparatus according to claim 2, wherein the image display unit displays the image of the range wider than the range of the image to be photographed by reducing a size of the image to be displayed.

4. The imaging apparatus according to claim 2, further comprising a wide-angle image generating unit that executes image integration while moving an area of same size as the image to be photographed in the image displayed by the image display unit, paints a range where the image integration has been completed, and executes the image integration over an entire area of the image displayed by the image display unit, to generate a wide-angle image.

5. An image processing method comprising:
acquiring an image of an object of photography through a lens of an imaging apparatus;
displaying the image acquired at the acquiring to an operator;
detecting an angular movement amount of the imaging apparatus;
calculating an image movement amount based on the angular movement amount detected at the detecting of the angular movement amount; and
displaying a current position of the object of photography superimposed onto the image displayed at the displaying the image acquired based on the image movement amount calculated at the calculating.

6. The imaging processing method according to claim 5, wherein the displaying the image acquired includes displaying an image of a range wider than a range of an image to be photographed.

7. The imaging processing method according to claim 6, wherein the displaying the image acquired includes displaying the image of the range wider than the range of the image to be photographed by reducing a size of the image to be displayed.

8. The imaging processing method according to claim 6, further comprising:
executing image integration while moving an area of same size as the image to be photographed in the image displayed at the displaying the image acquired;
painting a range where the image integration has been completed; and
executing the image integration over an entire area of the image displayed at the displaying the image acquired, to generate a wide-angle image.

9. A non-transitory computer-readable medium comprising computer readable program codes, performed by a processor, the program codes when executed causing the processor to execute:
acquiring an image of an object of photography through a lens of an imaging apparatus;
displaying the image acquired at the acquiring to an operator;
detecting an angular movement amount of the imaging apparatus;
calculating an image movement amount based on the angular movement amount detected at the detecting of the angular movement amount; and
displaying a current position of the object of photography superimposed onto the image displayed at the displaying the image acquired based on the image movement amount calculated at the calculating.

10. The non-transitory computer-readable medium according to claim 9, wherein the displaying of the image acquired includes displaying an image of a range wider than a range of an image to be photographed.

11. The non-transitory computer-readable medium according to claim 10, wherein the displaying the image acquired includes displaying the image of the range wider than the range of the image to be photographed by reducing a size of the image to be displayed.

12. The non-transitory computer-readable medium according to claim 10, further comprising:
executing image integration while moving an area of same size as the image to be photographed in the image displayed at the displaying the image acquired;
painting a range where the image integration has been completed; and
executing the image integration over an entire area of the image displayed at the displaying the image acquired, to generate a wide-angle image.
